(19) United States
(12) Patent Application Publication
(10) Pub. No.: US 2014/0016782 A1
(43) Pub. Date: Jan. 16, 2014

(54) SYSTEM FOR CONTROLLING AUDIO FREQUENCIES OF ELECTRONIC APPLIANCES AND A METHOD OF THE SAME

(71) Applicant: BBPOS LIMITED, New Territory (CN)

(72) Inventor: Hwai Sian TSAI, New Territory (CN)

(73) Assignee: BBPOS LIMITED, New Territory (CN)

(21) Appl. No.: 13/845,396

(22) Filed: Mar. 18, 2013

(30) Foreign Application Priority Data
Jul. 10, 2012 (CN) 201210236699.2

(51) Int. Cl. H04S 7/00

(52) U.S. Cl. CPC H04S 7/307
USPC 381/1; 381/98

(57) ABSTRACT

The system comprises a master controller and an audio plug connected to the master controller. The audio plug includes at least four contacts electrically connected to corresponding poles of an audio frequency interface. Electrical coupling devices are disposed on circuits which respectively connect a first contact and a second contact with the master controller. The circuits between each electrical coupling devices and the correspondent contact are short circuits.

### FIELD OF THE INVENTION

The present invention relates to electronic appliances, especially to a system for controlling audio frequencies of electronic appliances and a method of the same that are adapted to different polarities of cellphones or Tablet PCs when they are connected.

### DESCRIPTION OF THE RELATED ART

The 3.5 mm hands-free interface applied in the smartphone, the Tablet PC, the Internet Media Player, and the Video Game is not only served as an audio frequency interface but also served as a data transmission passage. For example, electronic appliances such as the Electronic Data Capture are able to connect to cellphones or computers via the passage.

Referring to FIGS. 1 to 3, there are two standards of the audio frequency interface 1 of the cellphone 100. One of the standards contains four terminals. According to an inserting direction, they are microphone input terminal 104, ground terminal 103, right sound channel output terminal 102, and left sound channel output terminal 101. The other standard contains the ground terminal 103, the microphone input terminal 104, the right sound channel output terminal 102, and the left sound channel output terminal 101. Obviously, the ground terminals 103 and the microphone terminals 104 are placed differently. In FIG. 2, one electronic appliance is provided with one standard audio frequency interface 1 in one cellphone. In FIG. 3, when an audio plug of the electronic appliance is inserted into a cellphone that is provided with the other audio frequency interface 1, the ground terminal 203 and the microphone output terminal 204 are unable to be coupled with the audio frequency interface 1. Evidently, it is inconvenient for people.

In order to settle afore inconvenience, a transforming circuit is provided. Herein, the transforming circuit in the electronic appliance automatically transforms polarities according to the inserting means of the audio plug of the cellphone when the audio frequency interface is connected. Therefore, the audio plug is adaptive to afore different audio frequency interfaces, which is more convenient. However, in practice, the transforming circuit complicates the circuit arrangement; the correlated cost is also increased, and the dimension of ended products is adversely bulky. Concurrently, the transforming circuit easily distorts and weakens output signals and input signals, which may result in unreliable communication.

Consequently, afore disadvantages should be amended.

### SUMMARY OF THE INVENTION

The main object of the present invention is to provide a system for controlling audio frequencies of electronic appliances; the correlated structure and circuit are simple. When no transforming circuit is needed, a vacancy is reserved, which decreases manufacturing costs and is also more convenient.

A further object of the present invention is to provide a method for controlling audio frequencies of electronic appliances; the method is simple because no transforming circuit is needed while an audio plug of the electronic appliance is adaptive to audio frequency interfaces of two different standards.

The present invention is achieved as follows:

a system for controlling audio frequencies of electronic appliances comprises a master controller and an audio plug connected to the master controller; the audio plug includes at least four contacts electrically connected to corresponding poles of an audio frequency interface; the contacts are sequentially defined as a first contact, a second contact, a third contact, and a fourth contact according to an inserting direction of the audio plug; wherein, the first contact and the second contact are both controlled by the master controller as an audio frequency output module; one of the third contact and the fourth contact is a ground contact that is utilized to electrically contact an output contact of a zero potential corresponding to the audio frequency interface, and the other thereof is an audio frequency input contact .

A method for controlling audio frequencies of electronic appliances includes steps of:

(1) preparing an audio plug of an electronic appliance which includes at least four contacts electrically connected to corresponding poles of an audio frequency interface; the contacts are sequentially defined as a first contact, a second contact, a third contact, and a fourth contact according to an inserting direction of the audio plug;

(2) applying a master controller to define both the first contact and the second contact as an audio frequency output module, so that an audio frequency input is conducted when an audio input pole of the audio frequency interface contacts with either the first contact or the second contact; and

(3) defining one of the third contact and the fourth contact as a ground contact and the other thereof as an audio frequency input contact that is utilized to electrically contact an output contact of a zero potential corresponding to the audio frequency interface.

Accordingly, the present invention achieves effects as follows:

1. The structure and the circuit arrangement of the present invention are simpler since fewer parts are needed. Especially, a transforming circuit is exempted from the present invention, which reserves a vacancy and diminishes manufacturing costs. Preferably, it is more convenient.

2. An audio frequency input terminal is controlled as a zero potential for outputting. Thereafter, the ground terminal is parallelly connected to an audio frequency output terminal; accordingly, no matter the first contact or the second contact of the audio plug is contacted with an input pole of the audio frequency interface, an audio inputting is contributed. Thereby, the audio plug of the electronic appliance is adaptive to two different kinds of audio frequency interfaces. Favorably, the practical method is uncomplicated, and it is beneficial for promotion.

### BRIEF DESCRIPTION OF THE DRAWINGS

FIG. 1 is a schematic view showing a conventional 3.5 mm audio plug (four-section type);

FIG. 2 is a frame chart of a conventional first standard audio frequency interface;

FIG. 3 is a frame chart of a conventional second standard audio frequency interface;

FIG. 4 is a frame chart showing an audio plug of an electronic appliance connected to a first standard audio frequency interface in the present invention; and

FIG. 5 is a frame chart showing an audio plug of an electronic appliance connected to a second standard audio frequency interface in the present invention.

### DETAILED DESCRIPTION OF THE PREFERRED EMBODIMENTS

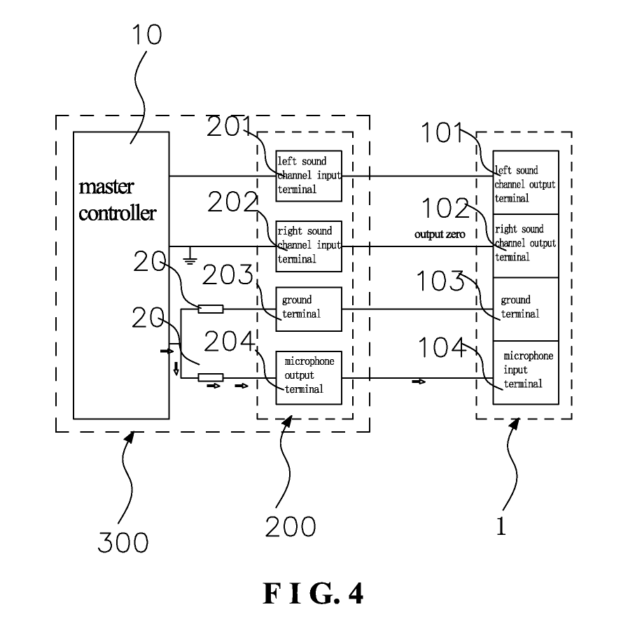

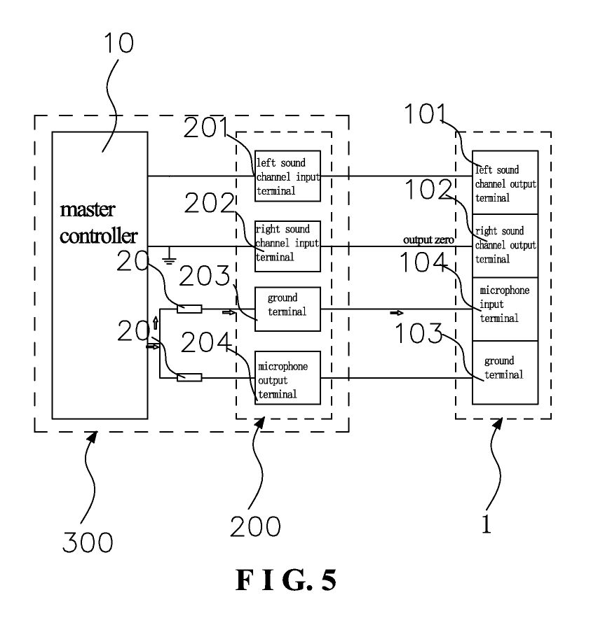

Referring to FIGS. 4 and 5, a preferred embodiment of the present invention is shown. An electronic appliance indicated herein is a part of the other electronic appliance (such as a smartphone, a Tablet PC, an Internet Media Player, or a video game). The electronic appliance and the other electronic appliance are connected by an audio plug and an audio frequency interface so as to achieve communication therebetween.

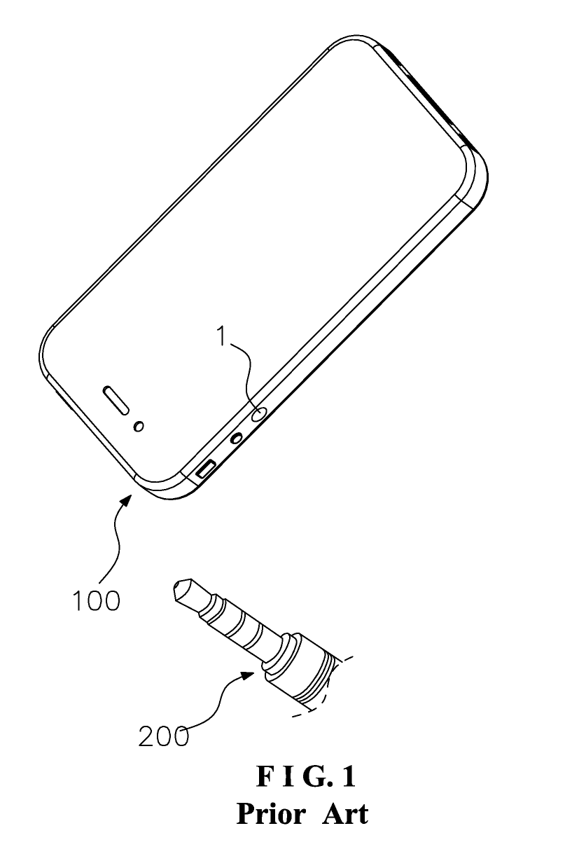

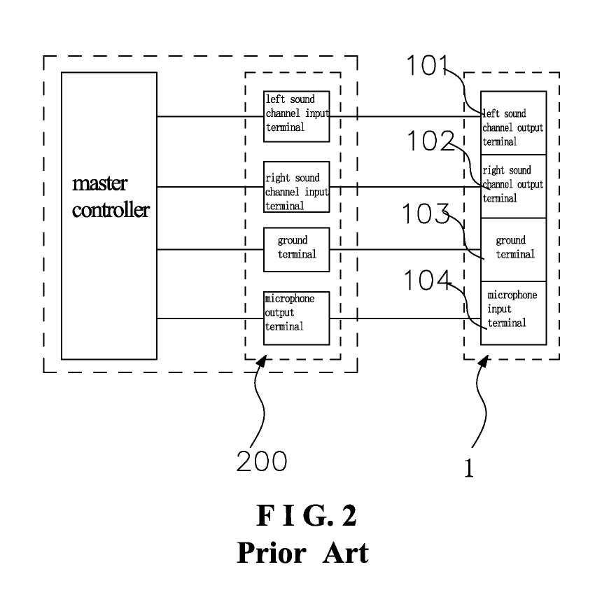

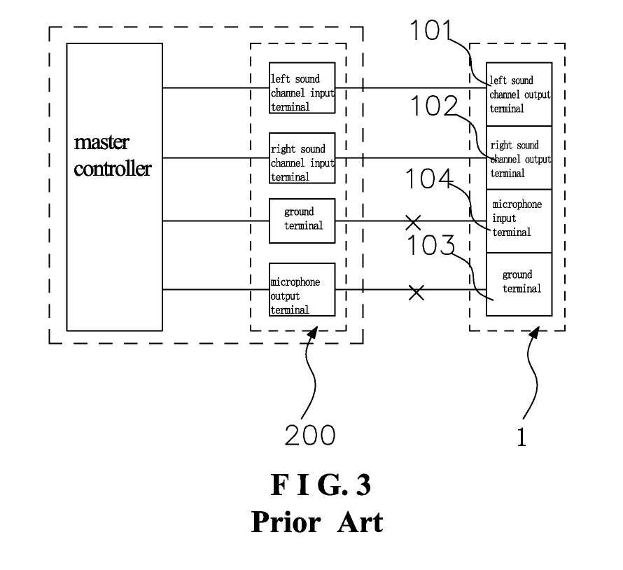

In FIG. 1 to FIG. 3, the single audio plug 200 is unadaptable to two different kinds of standard audio frequency interfaces 1. The audio frequency interface 1 of the cellphone 100 in this embodiment is adopted in the audio frequency interface coupled to the audio plug 200 shown in FIGS. 1 to 5. the audio frequency interface 1 is a 3.5 mm standard audio frequency interface. Besides being served as an audio frequency interface, the audio frequency interface is also served as a data transmission passage. For example, an electronic data capture is able to connect to a cellphone or a computer via afore passage.

A system for controlling audio frequencies of an electronic appliance 300 of the present invention comprises a master controller 10 (composed of a micro CPU or a customized chip), and an audio plug 200 connected to the master controller 10. The audio plug 200 includes at least four contacts electrically connected to corresponding poles of the audio frequency interface 1. According to an inserting direction of the audio plug 200, the contacts are sequentially defined as a first contact, a second contact, a third contact, and a fourth contact. Wherein, a plurality of electrical coupling devices 20 are correspondently disposed on circuits which respectively connect the first contact and the second contact with the master controller 10. electrical coupling devices 20, e.g. resistors, capacitors, inductors or their combinations , such as resistor-capacit or network. The circuits between each electrical coupling devices 20 and the correspondent contact are short circuits, and the first contact and the second contact are controlled by the master controller 10 as an audio frequency output module. One of the third contact and the fourth contact is a ground contact, and the other thereof is an audio frequency input contact. The cellphone or the Tablet PC connected to the audio plug is controlled to output zero potential to the ground contact, which allows the electronic appliance to acquire a requisite zero potential reference without having any relationship with contacting means of the first contact and the second contact.

In FIG. 4, according to an inserting direction, the four contacts are microphone output terminal 204, ground terminal 203, right sound channel input terminal 202, and left sound channel input terminal 201. In the audio frequency interface 1, the correspondent poles are microphone input terminal 104, ground terminal 103, right sound channel output terminal 102, and left sound channel output terminal 101. In FIG. 5, in the audio frequency interface 1, the correspondent poles are ground terminal 103, microphone input terminal 104, right sound channel output terminal 102, and left sound channel output terminal 101. When the zero potential is output via the left sound channel output terminal 101 or the right sound channel output terminal 102 controlled by software in the cellphone or the Tablet PC, the correspondent left sound channel input terminal 201 or the right sound channel input terminal 202 is served as a ground contact. When the right sound channel output terminal 102 or the left sound channel output terminal 101 in the audio frequency interface of the cellphone or the Tablet PC is controlled by the cellphone or the Tablet PC as an audio frequency for outputting, the correspondent right sound channel output terminal 202 or the left sound channel output terminal 201 is served as an input contact of signals from the cellphone or the Tablet PC to the controller. The ground terminal 203 and the microphone output terminal 204 are connected to the audio frequency output module of the master controller 10 in the electronic appliance 300. Therefore, no matter the structure in FIG. 4 or the structure in FIG. 5 is adopted by the audio frequency interface 1, the ground terminal 203 and the microphone output terminal 204 are connected to the audio frequency output module of the master controller 10 in the electronic appliance 300. Thereby, no matter the audio frequency input pole of the audio frequency interface 1 is contacted with the ground terminal 203 or the microphone output terminal 204 of the audio plug 200, an audio frequency input is contributed. Namely, the electronic appliance 300 provided with the system for controlling audio frequencies is able to be coupled to afore two different kinds of audio frequency interfaces 1. Preferably, no extra part is needed, and no complicated operation is required.

To sum up, the structure and the circuit of the present invention are simpler, which also reserves vacancies and saves costs. Preferably, signals that are output or input do not weaken and distort; the communication is more reliable. The audio frequency input terminal in the conventional technique is served as the ground terminal, and the correspondent audio frequency of the audio frequency interface outputs the pole for outputting the zero potential, so that the ground terminal achieves the zero potential reference. Moreover, the ground terminal and the audio frequency output terminal in the conventional technique are parallelly connected. Thus, no matter the audio frequency output pole of the audio frequency interface is connected to the first contact or the second contact of the audio plug, the audio frequency input is contributed. As a result, the audio plug of the electronic appliance is suited to two different kinds of audio frequency interfaces; the operating means is easy, and it is beneficial for promotion.

While we have shown and described the embodiment in accordance with the present invention, it should be clear to those skilled in the art that further embodiments may be made without departing from the scope of the present invention.

I claim:

1. A system for controlling audio frequencies of electronic appliances comprising a master controller and an audio plug connected to said master controller; said audio plug including at least four contacts electrically connected to corresponding poles of an audio frequency interface; said contacts being sequentially defined as a first contact, a second contact, a third contact, and a fourth contact according to an inserting direction of said audio plug; wherein, said first contact and said second contact are both controlled by said master controller as an audio frequency output module; one of said third contact and said fourth contact being a ground contact that is utilized to electrically contact an output contact of a zero potential corresponding to said audio frequency interface, and the other thereof being an audio frequency input contact.

2. The system as claimed in claim 1, wherein, a plurality of electrical coupling devices are correspondently disposed on circuits which respectively connect said first contact and said second contact with said master controller, said circuits between each electrical coupling devices and said correspondent contact are short circuits.

3. The system as claimed in claim 1, wherein, said audio frequency interface provides a left sound channel output contact or a right sound channel output contact of that serves to emit zero potential.

4. The system as claimed in claim 1, wherein, said audio input contact is a left sound channel input contact or a right sound channel input contact.

5. A method for controlling audio frequencies of electronic appliances as claimed in claim 1 including steps of:
(1) preparing an audio plug of an electronic appliance which includes at least four contacts electrically connected to corresponding poles of an audio frequency interface; wherein, said contacts are sequentially defined as a first contact, a second contact, a third contact, and a fourth contact according to an inserting direction of said audio plug;
(2) applying a master controller to define both said first contact and said second contact as an audio frequency output module, so that an audio frequency input is conducted when an audio input pole of said audio frequency interface contacts with either said first contact or said second contact; and
(3) defining one of said third contact and said fourth contact as a ground contact that is utilized to electrically contact an output contact of a zero potential corresponding to said audio frequency interface and the other thereof as an audio frequency input contact.

6. The system as claimed in claim 5, wherein, a plurality of electrical coupling devices are correspondently disposed on circuits which respectively connect said first contact and said second contact with said master controller, said circuits between each electrical coupling devices and said correspondent contact are short circuits.
